(19) United States
(12) Patent Application Publication
(10) Pub. No.: US 2020/0127453 A1
(43) Pub. Date: Apr. 23, 2020

(54) DC HIGH-VOLTAGE ELECTRICAL INSTALLATION AND METHOD FOR CONTROLLING A CUT-OFF APPARATUS IN SUCH AN INSTALLATION

(71) Applicant: SUPERGRID INSTITUTE, Villeurbanne (FR)

(72) Inventors: Christophe CREUSOT, Pizay (FR); Issam AIT BRAHIM, Lyon (FR); Alberto BERTINATO, Lyon (FR); Dieynaba Sakiliba LOUME, Villeurbanne (FR)

(21) Appl. No.: 16/471,665

(22) PCT Filed: Dec. 20, 2017
(86) PCT No.: PCT/FR2017/053749

§ 371 Date: Aug. 2, 2019

(30) Foreign Application Priority Data
Dec. 20, 2016 (FR) 1662822

(51) Int. Cl. H02H 9/02

(52) U.S. Cl. CPC H02H 9/02; H02H 7/268

(57) ABSTRACT

A DC high-voltage electrical installation comprises a switching device for switching an electric current in the main circuit, and a method for controlling the closure of a switching device in such an installation. The installation includes a controlled variable resistor system making it possible to modify the resistance value of the resistor system seen by the current flowing through the main electrical circuit. The resistance value takes at least three distinct values: high, a lower value, and at least one nonzero intermediate value comprised between the high value and the low value. The installation includes a coordination device making it possible to control switching times of the resistance values of the resistor system.

The invention relates to a DC high-voltage electrical installation comprising an apparatus for cutting-off a DC high-voltage electric circuit.

In a traditional manner, electrical networks on a region, country or continent scale are known, in which electric currents are conveyed over several tens, hundreds or thousands of kilometers. The development of such networks or portions of high-voltage or very high-voltage direct current networks are currently considered. In such networks, the high-voltage conductors may be arranged in particular in the form of overhead lines or underground or submarine cables.

Of course, power cut-off apparatuses are provided in the high-voltage networks to cut-off the flow of current in a given conductor. Generally, a cut-off apparatus, in its open position, separates two parts of an electric circuit, one of which can be connected to a power supply which, in the considered cases, is under high-voltage. Among these cut-off apparatuses, circuit breakers are provided, in case of anomalies on the circuit, for quickly opening the electric circuit constituted by the conductor. A circuit breaker is in particular provided to bear an on-load opening, that is to say an opening of an electric circuit in which flows a current of maximum nominal intensity under the nominal voltage, or even, in case of an electric fault in the circuit, a short-circuit current exceeding the maximum nominal intensity. Other cut-off apparatuses, the disconnectors, are more particularly provided for separating, in the open position, two parts of an electric circuit, one of which is for example connected to a power supply, ensuring a sufficient separation distance to guarantee permanent electrical insulation.

When a cut-off apparatus has been opened and when it is necessary to reclose it to restore flow of the current in the circuit, one can be faced with the issue of a very high current draw in the part of the circuit that was previously insulated from the power supply by the cut-off apparatus, which is arbitrarily called downstream part. This is all the more important in the case where this downstream part includes an underground or submarine cable of great length, for example of a length greater than 10 kilometers, or even greater than 100 kilometers. Indeed, such cables generally form a significant capacitance, in particular due to their large capacitance per unit length and/or their great length, with land or water. Upon powering up a cable, that is to say at the time of closing the cut-off apparatus, the capacitance of the cable tends to create a very significant current draw. Without particular protective measure, this current draw may far exceed twice the maximum nominal intensity of the current in the circuit. This current draw can then damage some elements of the circuit.

In the field of high-voltage alternating current networks, it is known to provide an insertion resistor inserted into the electric circuit at the time of turning-on of a line to limit the overvoltage that may occur during such a maneuver. It is also known, still in the field of the alternating current high-voltage networks, to provide an insertion resistor or inductor associated with a compensator bank of reactive compensation, or to provide an insertion resistor or inductor associated with a transformer to limit the draw current upon turning-on of the vacuum transformer.

However, the problem of draw current peaks in DC high-voltage circuits has not been addressed so far.

The invention therefore aims at proposing a solution for limiting the current draw to a controlled value, for example to a value not exceeding twice the value of the maximum nominal intensity of the current in the circuit. This allows, in some applications involving converters, in particular AC/DC converters, avoiding the blocking of the active components of the AC/DC converters, namely the Insulated Gate Bipolar Transistors (generally called IGBT). Moreover, the invention aims the second object of minimizing the time of restoring the nominal current in the conductor, particularly when the current restoration succeeds an operation of eliminating a fault current. The solution consisting in providing an insertion resistor, as used in the field of alternating currents, is not directly transposable, in particular because it leads to too significant nominal current restoration times.

For this purpose, the invention proposes a DC high-voltage electrical installation comprising an apparatus for cutting-off a DC high-voltage electric circuit, of the type comprising a main circuit in which flows an operating electric current under DC high-voltage during a steady operating state of the installation, the cut-off apparatus being likely to switch from an open state in which it interrupts the flow of an electric current in the main circuit to a closed state in which it allows the flow of an electric current in the main circuit.

The installation is characterized in that it includes a controlled variable resistance system comprising a resistance device associated with a switching device for modifying the resistance value of the resistance system, seen by the current flowing in the main electric circuit, said resistance value taking at least three distinct values, comprising at least one higher value, one lower value, and at least one non-zero intermediate value comprised between the lower value and the higher value, and in that the installation includes a coordination device for controlling switching instants of the resistance values of the resistance system as a function of a closing instant of the cut-off apparatus from its open state to its closed state.

According to other optional characteristics of the invention, taken alone or in combination:
the installation may include a controlled variable resistance system for which said resistance value takes at least two distinct non-zero intermediate values comprised between the lower value and the higher value.
the resistance device may include at least two discrete insertion resistors, and the switching device may include at least two distinct insertion switches, separate from the cut-off apparatus, which present each an open state of current interruption through the switch and a closed state of current passage through the switch, and which are each associated with a respective associated discrete insertion resistor for selectively controlling the passage of the current in the associated discrete insertion resistor.
at least one insertion switch can be arranged in the main circuit so as to be, in its closed state, traversed by the operating current, and in that the associated discrete insertion resistor can be arranged in the main circuit electrically in parallel with the associated insertion switch.
first and second insertion switches may be arranged in the main circuit so as to be traversed by the operating current in their closed state, and first and second discrete insertion resistors, respectively associated with the first and second insertion switches, can be each arranged respectively electrically in parallel with the associated insertion switch.
at least a first switch and a first associated resistor can be arranged electrically in series in a same first bypass branch of the electric circuit; a second switch and a second associated resistor can be arranged electrically in series in a same second bypass branch of the electric circuit, the first bypass branch and the second bypass branch being arranged electrically in parallel with each other and the two branches being arranged electrically in parallel with the cut-off apparatus.
at least one insertion switch may be mechanical.
at least one insertion switch may be electronic.
at least one insertion switch may be mechanically controlled by a displacement of at least one member of the cut-off apparatus, for example by a relative displacement of two contacts or pairs of electrical contacts of the cut-off apparatus.
at least one insertion switch can be electronically controlled.
the controlled variable resistance system may comprise a rheostat comprising a resistive element associated with a movable switching slider controlled in displacement to change the resistance value of the resistance system, seen by the current flowing in the electric circuit.
the movable switching slider can be controlled in displacement by the coordination device. the coordination device may include an electronic control unit.
the cut-off apparatus can be a circuit breaker.
the higher resistance value of the resistance system, seen by the current flowing in the main circuit, is for example equal to or greater than the quotient of the voltage of the network by the current of desired maximum peak, quotient from which is removed the equivalent wave impedance value of the electric circuit, excluding the controlled variable resistance system:

$$RSysEqSup = \frac{Udc}{Ides} - Zeq$$

The invention furthermore relates to a method for controlling the closing of a cut-off apparatus, which may be mechanical, in a DC high-voltage electric circuit of a DC high-voltage electrical installation, characterized in that the method includes:
the setting of a resistance value of a resistance system with a controlled variable resistance, seen by the current flowing in the electric circuit, to a higher value;
the establishment of an electrical flow in the DC high-voltage electric circuit through the resistance system with a controlled variable resistance;
the modification of the resistance value of the resistance system to reach, on expiry of a first period following the establishment of the electrical flow, an intermediate value;
after expiry of the first period following the establishment of the electrical flow, the modification of the resistance value of the resistance system to reach, on expiry of a second period following the establishment of the electrical flow, a lower value.

In a first variant, such a method may include:
the setting of a resistance value of a resistance system with a controlled variable resistance, seen by the current flowing in the electric circuit, to a higher value;
the closing of the cut-off apparatus;
after the closing of the cut-off apparatus, the modification of the resistance value of the resistance system to reach, on expiry of a first period, following the closing of the cut-off apparatus, an intermediate value;
after expiry of the first period, the modification of the resistance value of the resistance system to reach, on expiry of a second period following the closing of the cut-off apparatus, a lower value.

In a second variant, such a method may include:
the setting of a resistance value of a resistance system with a controlled variable resistance, seen by the current flowing in the electric circuit, to a higher value, and the establishment of the flow of an electric current through the resistance system with a controlled variable resistance by the closing of an insertion switch;
the modification of the resistance value of the resistance system to reach, on expiry of a first period, following the establishment of the flow of an electric current through the resistance system with a controlled variable resistance, an intermediate value, by the closing of a second insertion switch;
after expiry of the first period, the modification of the resistance value of the resistance system to reach, on expiry of a second period following the establishment of the flow of an electric current through the resistance system with a controlled variable resistance, a lower value, by the closing of the cut-off apparatus.

The installation can be configured, in particular by appropriate programming of an electronic control unit, so that the resistance value of the resistance system with a controlled variable resistance is controlled to take a succession of decreasing discrete values, and so that a duration of insertion (Ti−T(i−1)) of an intermediate resistance value, for which the resistance value of the resistance system with a controlled variable resistance is controlled to take said discrete intermediate value, is equal to or greater than:

$$- ln ( \frac{RSysEq ( i + 1 ) + Zeq}{RSysEq ( i ) + Zeq} ) \cdot RSysEq ( i ) \cdot Ceq$$

Where:
RSysEq(i) is an intermediate resistance value of the resistance system with a controlled variable resistance, seen by the current flowing in the electric circuit;
T(i−1) is the instant at which the resistance system with a controlled variable resistance is controlled to take said intermediate value RSysEq(i);
RSysEq(i+1) is a next resistance value in the order of succession of the discrete resistance values of the resistance system with a controlled variable resistance, seen by the current flowing in the electric circuit;
T(i) is the instant at which the resistance system with a controlled variable resistance (26) is controlled to move from said intermediate value (RSysEq(i)) to the next resistance value (RSysEq(i+1));
Zeq is the equivalent wave impedance value of the electric circuit (24), including any network connected to the main circuit, excluding the controlled variable resistance system;
Ceq is the equivalent capacitance of the electric circuit (24), including any network connected to the main circuit.

Preferably, it is expected that the duration of insertion (Ti−T(i−1)) of an intermediate value RSysEq(i) for which the resistance value of the resistance system with a controlled variable resistance is controlled to take said discrete intermediate value RSysEq(i), is ranging from 1 time to 1.5 times the value:

$$ln ( \frac{RSysEq ( i + 1 ) + Zeq}{RSysEq ( i ) + Zeq} ) \cdot RSysEq ( i ) \cdot Ceq$$

### Various other characteristics appear from the description given below with reference to the appended drawings which show, by way of non-limiting examples, embodiments of the object of the invention.

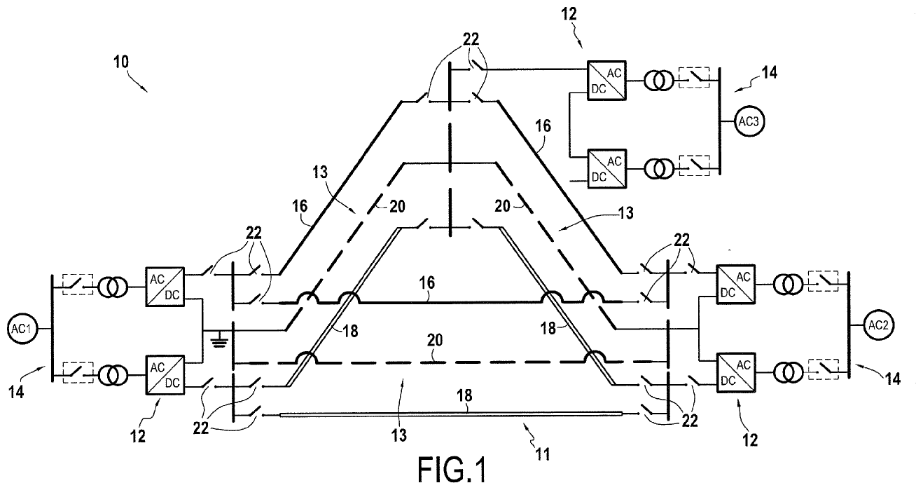

FIG. 1 illustrates an example of a high-voltage electrical network including in particular a portion of a DC high-voltage network connected to different portions of an AC high-voltage network by AC/DC converters, said portion of a DC high-voltage network including cut-off, for example mechanical, apparatuses.

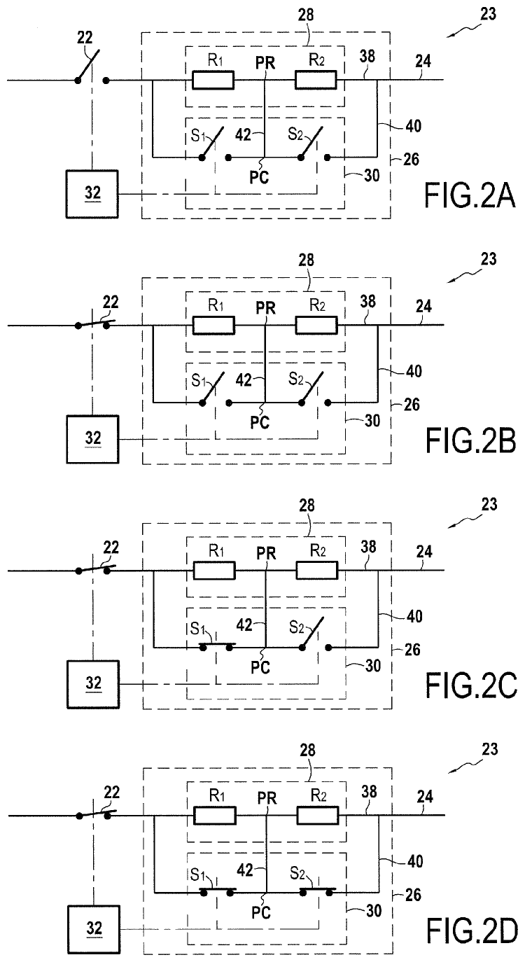

FIGS. 2A to 2D schematically illustrate various states of an installation including, in a DC high-voltage electric circuit, a cut-off apparatus, for example of the circuit breaker type, and a controlled variable resistance system associated with the cut-off apparatus in accordance with to the teachings of the invention.

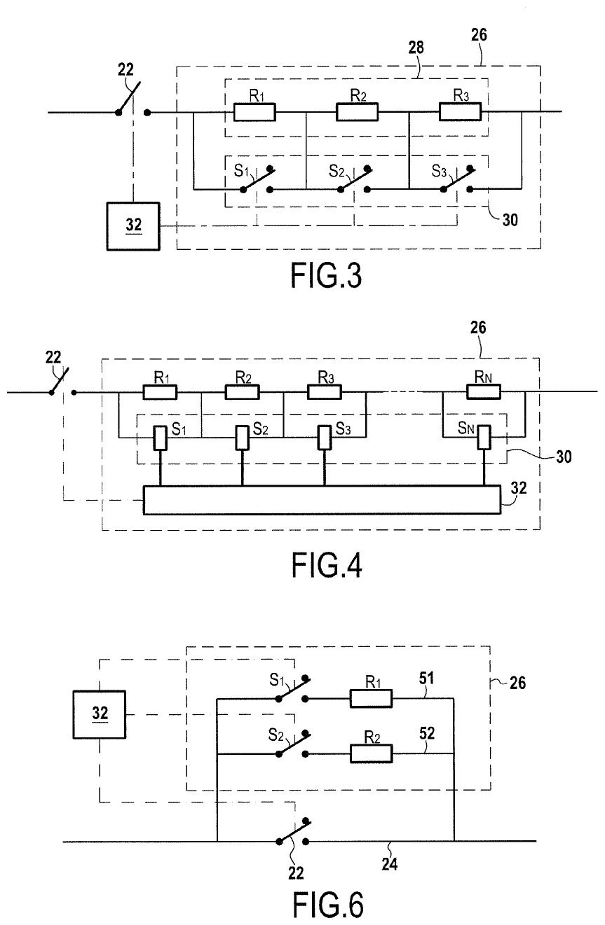

FIGS. 3 and 4 are views similar to those of FIG. 2A each illustrating a variant of the controlled variable resistance system.

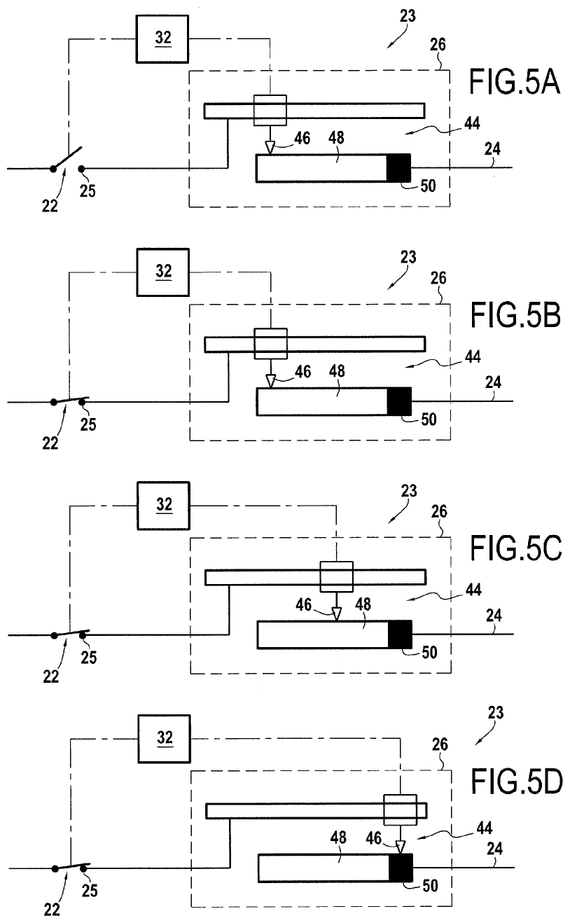

FIGS. 5A to 5D are views similar to those of FIGS. 2A to 2D each schematically illustrating different states of a variant of the controlled variable resistance system.

FIG. 6 is a view similar to that of FIG. 2A illustrating a variant of the controlled variable resistance system.

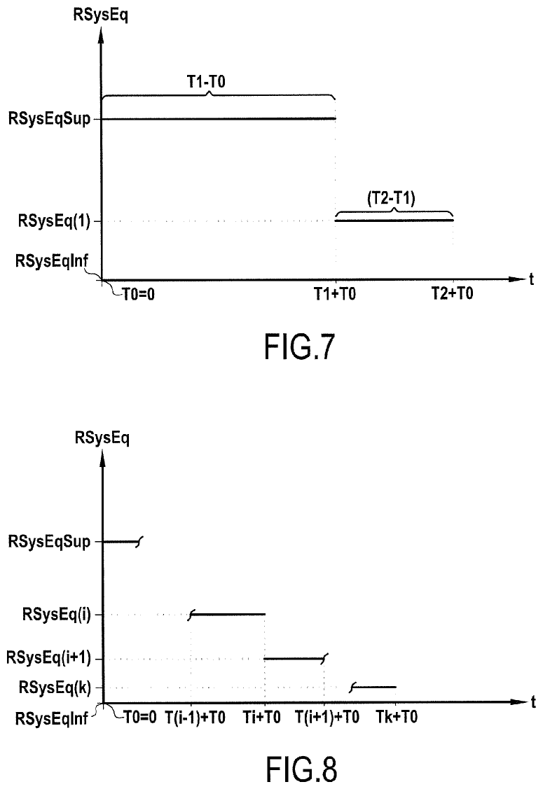

FIG. 7 is a graph which illustrates the variations, as a function of time, of the resistance value of the resistance system with a controlled variable resistance, seen by the current flowing in the main circuit, for the embodiment of FIGS. 2A to 2D, within the context of a control method according to the invention.

FIG. 8 is a graph which illustrates the variations, as a function of time, of the resistance value of the resistance system with a controlled variable resistance, seen by the current flowing in the main circuit, for a resistance system including any number of intermediate resistance values, within the context of a control method according to the invention.

FIG. 1 illustrates a high-voltage electrical network system 10 in which the invention can be implemented. This network system 10 includes a portion of DC high-voltage electrical network 11 which is connected, by AC/DC converter systems 12, to different portions of AC high-voltage electrical network 14, here three in number. In the example illustrated, the portion of DC high-voltage electrical network 11 includes three sub-portions of DC high-voltage network 13, each of which connects a converter system 12 associated with a portion of AC network 14 with another converter system 12 associated with another portion of AC network 14. In the example illustrated, the three sub-portions of DC high-voltage network 13 therefore connect the three portions of AC networks 14 in a triangle configuration.

In the present text, a device in which the nominal operating voltage is greater than 1000 V AC or 1500 V DC is considered as high-voltage device. Such a high-voltage is, in a complementary manner, also qualified as very high-voltage when it is greater than 50 000 V AC or 75 000 V DC.

Each sub-portion of DC high-voltage network 13 includes a DC high-voltage conductor with a positive potential 16, a DC high-voltage conductor with a negative potential 18, and a conductor connected to the neutral potential 20. The high-voltage conductors 16, 18 comprise, for example, at least one of the three sub-portions of DC high-voltage networks 13, underground cables or submarine cables.

In the illustrated example, each DC high-voltage conductor 16, 18 determines a DC high-voltage electric circuit. The portion of DC high-voltage electrical network 11 includes, in the DC high-voltage electric circuits defined by the DC high-voltage conductors 16, 18, electrical cut-off apparatuses 22 each of which may be in an open state capable of interrupting the flow of electric current in the electric circuit in question, or in a part thereof, or in a closed state in which it allows the flow of an electric current in the electric circuit in question.

The electrical cut-off apparatuses 22 can be in particular of the circuit breaker, disconnector, switch, contactor, cutout types, etc. In the more particular examples described below, the cut-off apparatus 22 is for example a circuit breaker.

The electric cut-off apparatuses can be in particular:
mechanical apparatuses, in which the electrical cut-off is obtained by displacement, in particular by spacing, of two electrical contacts or pairs of electrical contacts;
electronic apparatuses, for example at IGBT; or
hybrid apparatuses.

In mechanical apparatuses, the displacement of the electrical contacts is generally carried out by maneuvering members or mechanical, pneumatic, hydraulic or electrical actuators, possibly through a movement transfer kinematics. This displacement can be controlled electronically.

In a DC high-voltage network, for example of the type of the portion of DC high-voltage network 11 described above, it may be necessary to conduct turning-on operations aiming at establishing the flow of a current, previously interrupted, by an operation of closing at least one cut-off apparatus 22 of the network. In such a turning-on operation, the cut-off apparatus 22 is brought from its open state to its closed state. A turning-on operation may also be necessary after a protection sequence, that is to say, after a sequence during which a cut-off apparatus, in particular a circuit breaker, has opened to interrupt the flow of current in a circuit following the detection of abnormal conditions. A turning-on operation can also occur outside of a protection sequence, for example when a cable is re-powered up after maintenance, for example.

In the case of a protection sequence, a strategy consists in first eliminating a fault by opening all the DC high-voltage circuit breakers, in particular those directly associated with the DC output of the converter systems. Once the fault is identified, for example identified on one of the high-voltage conductors 16, 18, the network is re-powered up by the turning-on of the DC high-voltage circuit breakers except those surrounding the fault.

At the turning-on time, the DC high-voltage network, in the example of FIG. 1, the portion of DC high-voltage network 11, is seen as a large capacitance, therefore its turning-on produces a draw current which, without particular measures, may be caused to exceed, at the output of at least one converter, more than 2 times, or more than 3 times the maximum nominal intensity provided in the converter causing the automatic blocking of its IGBTs and therefore the loss of control of the converter. Moreover, in a DC high-voltage electric circuit, this could thus lead to the flow of currents of several thousands of amperes, even several tens of thousands of amperes. Such excessive current draws could only be damaging to the operation of the electrical installation as a whole, in particular by degradation of some components. For example, within the context of a network system 10 as described in FIG. 1, such excessive current draws during the turning-on of the current in an electric circuit defined by one of the high-voltage conductors 16, 18 could cause the blocking of IGBT of the converter systems 12, and therefore their loss of control.

Thus, in the particular case of a network system 10 as represented in FIG. 1, it may be desired to re-power up a DC high-voltage conductor without blocking of the IGBTs, in particular of the converter systems 12, and this over a conductor loading period considered as short as possible. For example, it may be desired that the intensity of the draw current which is established in the conductor considered during turning-on does not exceed twice the maximum nominal value of the operating current supposed to flow in this conductor.

Also, the invention proposes to associate, in the same electrical installation, at least one cut-off apparatus of a DC high-voltage electric circuit, a controlled variable resistance system for modifying the resistance value of the resistance system seen by the current flowing in the electric circuit.

The controlled variable resistance system has a resistance value capable of taking at least three distinct values, comprising at least one higher value, one lower value, and at least one non-zero intermediate value comprised between the lower value and the higher value. Note that the non-zero intermediate value is distinct from the lower value and the higher value.

The installation includes a coordination device for controlling switching instants of the resistance values of the resistance system as a function of a closing instant of the cut-off apparatus. This coordination makes it possible to associate the controlled variable resistance system with the cut-off apparatus, by ensuring that the closing of the cut-off apparatus is coordinated temporally with a variation of the resistance value of the resistance system.

FIGS. 2A to 5D illustrate different embodiments of an electrical installation 23 comprising a main circuit 24 in which flows an operating electric current, under DC high-voltage, during a steady operating state of the installation. The main circuit 24 may in particular be one of the high-voltage conductors 16, 18 of the portion of DC high-voltage network 11 represented in FIG. 1. The electrical installation 23 includes a cut-off apparatus 22, for example a direct current circuit breaker having an open state illustrated in FIG. 2A and FIGS. 3, 4, and 5A, wherein the apparatus 22 interrupts the flow in the electric circuit 24. The cut-off apparatus 22 also has a closed state, illustrated in FIGS. 2B to 2D and 5B to 5D, in which it allows the flow of an electric current in the electric circuit in question.

According to the invention, each of these electrical installations 23 includes a controlled variable resistance system 26 for changing the resistance value of the resistance system seen by the current flowing in the electric circuit. This controlled variable resistance system is inserted electrically in series in the main circuit 24.

The controlled variable resistance system 26 comprises a resistance device 28, 48, associated with a switching device 30, 46 for changing the resistance value of the resistance system seen by the current flowing in the electric circuit 24. Of course, this is the resistance seen by the electric current when a current flows in the main circuit 24, thereby implying in particular that the cut-off apparatus 22 is in its closed state.

The installation includes a coordination device 32 for controlling switching instants of the resistance values of the resistance system 26 as a function of a closing instant T0 of the cut-off apparatus. In particular, this coordination device 32 controls the switching device 30, 46 between different states. In the embodiments in which the cut-off apparatus 22 is a mechanical-type apparatus and in which the switching device is also of mechanical type, the coordination device 32 may comprise a direct mechanical link between the cut-off apparatus 22 and the switching device 30. In the same case, the coordination device may comprise one or more actuator(s), for example of the electric motor, hydraulic cylinder, or spring system types, associated with electrical or electronic driving means which control the actuator(s), for example depending on the state of the cut-off apparatus 22. In some embodiments, an offset of the orders on each member can be predefined once and for all. The electrical or electronic driving means can comprise in particular a conventional electronic control unit, specific to the resistance system 26 or to the installation 23 or integrated to a more complete electronic system, for example an electronic unit also driving the cut-off apparatus 22 and other elements of the network. This electronic control unit can be informed of the state of the cut-off apparatus 22 by a sensor. In the embodiments where either or both of the cut-off apparatus 22 and switching device 30 are of the electronic type, the coordination device 32 is also preferably at least partly of the electronic type, for example in the form of a conventional electronic control unit, specific to the resistance system 26 or to the installation 23, or integrated to a more complete system, for example a control system of the network in which the installation 23 is integrated.

In any case, the controlled variable resistance system 26 is designed so that said resistance value of the system, seen by the current flowing in the circuit 24, can take at least three distinct values, comprising at least one higher value, one lower value, and at least one non-zero intermediate value comprised between the lower value and the higher value.

As will be seen later, it is thus possible to provide that the cut-off apparatus 22 is brought into its closed state when the controlled variable resistance system 26 has a resistance value, seen by the circuit, called higher value. At this higher value, as will be seen below, the resistance limits the current intensity peak in the main circuit 24. Beyond a certain time, the controlled variable resistance system 26 can be switched to an intermediate value in which, while continuing to limit the intensity peak, the system 26 allows a faster capacitive loading of the main circuit 24. Finally, beyond a certain time, the controlled variable resistance system 26 can be switched to a lower value, which can be zero, for the nominal operation of the installation 23 with the lowest possible energy loss in the controlled variable resistance system 26.

In some embodiments, in particular those of FIGS. 2A to 4, the resistance device 28 includes at least two discrete insertion resistors R1, R2, and the switching device 30 includes at least two distinct insertion switches S1, S2, separate from the mechanical cut-off apparatus 22. The two distinct insertion switches S1, S2 each have an open state of current interruption through the switch S1, S2 and a closed state of current passage through the switch S1, S2. The two distinct insertion switches S1, S2 are each associated with a respective associated discrete insertion resistor R1, R2 for selectively controlling the passage of current in the associated discrete insertion resistor.

More particularly, the example of FIGS. 2A to 2D show that the controlled variable resistance system 26 comprises an electric circuit which is intercalated electrically in series in the main circuit 24 and which includes two electrically parallel branches namely a resistance branch 38 and a switching branch 40. The resistance branch 38 and the switching branch 40 meet at an upstream end and at a downstream end which are respectively electrically connected to an upstream part and to a downstream part of the main electric circuit 24. In the illustrated example, the cut-off apparatus 22 is arranged in the upstream portion of the main circuit 24 with respect to the controlled variable resistance system 26, but a reverse arrangement is possible.

In the present text, the notions “upstream” and “downstream” are purely arbitrary and do not necessarily imply a particular direction of flow of the electric current in the main circuit 24. However, it would be possible to imagine that the upstream part of the main circuit 24, still upstream of the cut-off apparatus 22, is connected to or includes a voltage source, while the downstream part of the main circuit 24, relative to the controlled variable resistance system 26, could be connected to or include a current consumer. In some embodiments, the downstream part of the main circuit 24 includes an overhead line or an underground cable or a submarine cable of great length, for example greater than 10 km, or even greater than 100 km.

In the resistance branch 38, the first discrete insertion resistor R1 and the second discrete insertion resistor R2 are arranged. These resistors are discrete in the sense that they are composed of a resistive component having a determined fixed value which, for given conditions of use, is not variable. They are also discrete in the sense that the two components are separate.

Note that a connection branch 42 electrically connects the resistance branch 38 with the switching branch 40. The connection branch 42 is electrically connected to the resistance branch 38 at a point PR located between the first discrete insertion resistor R1 and the second discrete insertion resistor R2. The point PR thus delimits an upstream section with respect to a downstream section of the resistance branch 38 in which there is respectively the first discrete insertion resistor R1 and the second discrete insertion resistor R2. The connection branch 42 is electrically connected to the switching branch 40 at a point PC which delimits an upstream section with respect to a downstream section of the switching branch 40 in which there is respectively the first insertion switch S1 and the second insertion switch S2.

With this configuration, it is understood that the first insertion switch S1 is arranged in the main circuit 24 so as to be traversed, in its closed state, by the operating current, and that the first associated discrete insertion resistor R1 is arranged in parallel with the associated insertion switch S1, in a bypass branch, here the upstream section of the switching branch 40. Similarly, the second insertion switch S2 is arranged in the main circuit 24 so as to be traversed, in its closed state, by the operating current, and the second associated discrete insertion resistor R2 is arranged electrically in parallel with the associated insertion switch S2, in a bypass branch, here the downstream section of the switching branch 40.

The first insertion switch S1 and the first associated discrete insertion resistor R1 form a first switchable resistive assembly, while the second insertion switch S2 and the second associated discrete insertion resistor R2 form a second switchable resistive assembly, both assemblies being inserted electrically in series with respect to each other in the main circuit 24.

In total, the first and second insertion switches S1, S2 are arranged in the main circuit 24 so as to be traversed by the operating current in their closed state, and the first and second discrete insertion resistors R1, R2, respectively associated with the first and second insertion switches S1, S2 are each arranged respectively electrically in parallel with the associated insertion switch.

The operation of this first embodiment of an electrical installation 23 will now be described in relation to FIGS. 2A to 2D.

FIG. 2A illustrates an initial state in which the cut-off apparatus 22 is in its open state. In this initial state, the resistance value of the resistance system 26 is set to its higher value. For this, in this exemplary embodiment, the first and second insertion switches S1, S2 are switched in an open state which, by virtue of their electrically parallel arrangement of the associated discrete insertion resistor R1, R2, imposes that any electric current passing through the controlled variable resistance system 26 must pass through the two discrete insertion resistors R1, R2 which are placed electrically in series in the resistance branch 38. In this configuration, the resistance value RSysEqSup of the controlled variable resistance system 26 is therefore equal to the sum R1+R2 of the resistance values of the two discrete insertion resistors R1 and R2. It is noted here that, in this embodiment, the switching of the two insertion switches S1, S2 in their open state is made in the absence of current in the main circuit 24 since the cut-off apparatus 22 is in an open state. These two insertion switches S1, S2 therefore do not need to have a particular capacity of interrupting a short-circuit current, unlike a circuit breaker.

FIG. 2B illustrates a closing instant T0 of the cut-off apparatus 22 in which it switches from its open state to its closed state for establishing a flow of electric current in the main electric circuit. The controlled variable resistance system 26 remains in the configuration described above in which it has its higher resistance value RSysEqSup, here equal to R1+R2, this higher resistance value RSysEqSup being the one seen by the electric current flowing in the main electric circuit 24 since the controlled variable resistance system 26 is arranged electrically in series with the cut-off apparatus 22 in the main electric circuit 24. In this way, this higher resistance value RSysEqSup, here equal to R1+R2 limits the current intensity peak upon the establishment of the flow of current in the main circuit 24.

On expiry of a first period T1 following the closing instant T0 of the cut-off apparatus 22, it is possible to switch the controlled variable resistance system so that it adopts an intermediate resistance value RSysEq(1), as illustrated in FIG. 7. This first period T1 is variable according to the installation and to the electrical characteristics of the network in which the installation is inserted, but will be generally less than one second, for example comprised between 1 ms and 100 ms. In the first example illustrated, the switching of the controlled variable resistance system 26 is made by switching of the switching device 30, in this case by the switching of one of the two insertion switches S1, S2 from its open state to its closed state. In the example illustrated in FIG. 2C, it is the first insertion switch S1 which is switched to its closed state, the second insertion switch S2 being kept in its open state. On the contrary, it could be decided to switch the second insertion switch S2 to its closed state, by keeping the first insertion switch S1 in its open state. By this switching of the switching device 30, the discrete insertion resistor associated with the insertion switch which is closed, in this case the first insertion resistor R1, is short-circuited. Indeed, the electric current in the main circuit 24 tends to flow in the upstream section of the switching branch 40, through the first insertion switch S1, and by the connection branch 42 to continue its flow in the downstream section of the resistance branch 38, through the second discrete insertion resistor R2. It is therefore understood that, in this state of the controlled variable resistance system 26, the resistance value of the system 26 which is seen by the electric current flowing in the main circuit 24 is an intermediate value RSysEq(1) which is equal to the value R2. This intermediate value is less than the higher value R1+R2 corresponding to the state of the system illustrated in FIG. 2B. This intermediate value is non-zero.

After expiry of the first period T1 following the closing instant of the cut-off apparatus 22, it is possible to switch again the controlled variable resistance system so that it adopts, on expiry of a second period T2 following the closing instant T0 of the cut-off apparatus, a lower resistance value. This second period T2, calculated from the closing instant T0, is variable according to the installation and to the electrical characteristics of the network in which the installation 23 is inserted, but will be generally less than one second, for example comprised between 1 ms and 100 ms, while of course being higher than the first period T1. The switching of the controlled variable resistance system 26 is made by switching of the switching device 30, in this case by switching of the second insertion switch S2 from its open state to its closed state as illustrated in FIG. 2D. By this switching of the switching device 30, the second associated discrete insertion resistor is also short-circuited, all the discrete insertion resistors S1, S2 thus being short-circuited. Indeed, the electric current in the main circuit 24 tends to flow only in the switching branch 40, through the first and second insertion switches S1, S2. No current, or a negligible current, flows in the resistance branch 38, therefore through the first and second discrete insertion resistors R1, R2. It is therefore understood that, in this state of the controlled variable resistance system 26, the resistance value of the system 26 which is seen by the electric current flowing in the main circuit 24 is a lower value. This lower value RSysEqInf is less than the intermediate value R2 corresponding to the state of the system illustrated in FIG. 2C. In the illustrated example, this lower value RSysEqInf corresponds to the resistance of the switching branch 40. This lower value is preferably zero or negligible.

Simulations have been carried out for an installation of the type of the one illustrated in FIGS. 2A to 2D, for a nominal DC high-voltage network of 320 kV DC in which the flow of an electric current under a maximum nominal intensity of 1500 A is provided. It has been assumed that the main circuit 24 has (excluding any controlled variable resistance system) an equivalent impedance of 8 Ohms and an equivalent capacitance of 108 microfarads. In the absence of any draw current limitation system, the simulations show that, upon closing of the cut-off apparatus 22, it is possible to have a draw current peak exceeding 40,000 amperes.

In the installation equipped with a controlled variable resistance system 26 as illustrated in FIGS. 2A to 2D, the simulations show that it is possible to limit the intensity peak value during the period of establishment of the current to a desired value of 2700 amperes, namely less than twice the maximum nominal intensity of the network, this intensity peak being very short and therefore being bearable by the network, by choosing the following values:

| | | |
|---|---|---|
| R1 | 75.2 | Ohms |
| R2 | 35.5 | Ohms |
| T1 | 12 | ms |
| T2 | 18.5 | ms |

By simple adaptation operations, those skilled in the art can vary the resistance values R1 and R2 and the periods T1 and T2 to find optimal values according in particular to the installation and to the network in which it is inserted.

More generally, a controlled variable resistance system can be sized to reach a desired value of the intensity peak during the establishment period of the current, by solving the following equations:

| | |
|---|---|
| Voltage of the network | U_{dc} |
| Desired maximum peak current | I_{des} |
| Equivalent capacitance of the | C_{eq} |
| main circuit, including any | |
| network connected to the | |
| main circuit | |
| Equivalent wave impedance | Z_{eq} |
| of the main circuit | |
| including any network | |
| connected to the main circuit | |
| (excluding controlled | |
| variable resistance system) | |
| Inserted total resistance | $Rtot = RSysEqSup = \\ R 1 + R 2 = \frac{{U}_{{d}_{c}}}{{I}_{des}} - {Z}_{eq}$ |
| Main circuit load constant | τ₁ = Rtot * Ceq |
| including any network | |
| connected to the main circuit, | |
| after insertion of RSysEqSup | |
| First switching period T1 | T1 can be chosen to minimize T2 |
| R2 | $R 2 = \frac{{U}_{dc}}{{I}_{des}} \cdot {e}^{\frac{T 1}{{τ}_{1}}} - {Z}_{eq}$ |
| R1 | R1 = Rtot − R2 |
| Second switching period T2 | $T 2 = - ln ( \frac{{Z}_{eq} \cdot {I}_{des}}{{U}_{dc} \cdot {e}^{\frac{- T 1}{{τ}_{1}}}} ) \cdot R 2 \cdot {C}_{eq} + T 1$ |

Concerning the parameter T1, the optimization rule is to minimize the function T2 as a function of T1, that is to say to determine a value of T1 for which the derivative of the function T2 as a function of T1 is zero (dT2/dT1=0). However, the choice of T1 is not critical because in the usual configurations, while keeping T1 in a range comprised between 0.2×T2 and 0.95×T2, a variation of T2 less than 20% of the minimum value of T2 is observed, that is to say T2 remains comprised between a minimum value T2 min and 1.2 T2 min.

FIG. 3 illustrates a variant of the first embodiment of the invention in which, instead of having, as in the previous example, two switchable resistive assemblies each consisting of an associated discrete insertion resistor R1, R2 electrically in parallel with an associated insertion switch S1, S2, the two assemblies being arranged electrically in series in the main circuit 24, the controlled variable resistance system 26 includes three switchable resistive assemblies each consisting of an associated discrete insertion resistor R1, R2, R3 electrically in parallel with an associated insertion switch S1, S2, S3, the three assemblies being arranged electrically in series in the main circuit 24. The operation of this controlled variable resistance system is directly deduced from the operation described for the first embodiment, by providing a third period corresponding to the switching of the third insertion switch S3 from its open state to its closed state.

In the installation equipped with a controlled variable resistance system 26 as illustrated in FIG. 3, with the same assumptions as previously, the simulations show that it is possible to limit the intensity peak value during the period of establishment of the current to a desired value of 2700 amperes, by choosing the following values:

| | | |
|---|---|---|
| R1 | 52.5 | Ohms |
| R2 | 37.3 | Ohms |
| R3 | 21 | Ohms |
| T1 | 7 | ms |
| T2 | 12.5 | ms |
| T3 | 15 | ms |

It can thus be seen that the time of establishment of the nominal current in the circuit is here of 15 ms, namely a little faster than the time of 18.5 ms obtained in the previous embodiment, and very close to the minimum time possible given the characteristics of the network, in the adopted assumption, of 11.9 ms.

Of course, it is still possible to reduce the total time of establishment of the nominal current, for the same current peak authorized, by increasing the number of insertion resistors and associated insertion switches.

FIG. 4 thus illustrates a controlled variable resistance system 26 including N discrete insertion resistors R1, R2, R3, . . . , RN and N associated insertion switches S1, S2, S3, . . . SN, in the same arrangement as previously illustrated, N representing an integer greater than 3.

In the first two variants in the invention illustrated in FIGS. 2A to 3, it is understood that it is possible to use mechanical insertion switches.

However, including in these variants, the insertion switches may comprise electronic switches, for example of the thyristor, TRIAC, MOSFET, IGBT, etc. types. Such a solution will be preferred for a controlled variable resistance system 26 such as the one of FIG. 4 including a significant number of insertion switches, in particular more than 3 insertion switches.

The switching of one or more of all the insertion switches can be mechanically controlled, for example by a displacement of at least one member of the mechanical cut-off apparatus. Alternatively, the switching of one or more or of all the insertion switches may be electronically controlled.

In the variants described in FIGS. 3 and 4, the controlled variable resistance system 26 has a resistance value which, depending on the setting, may take at least two distinct non-zero intermediate values comprised between the lower value and the higher value.

However, in these examples, the intermediate resistance values are discrete values between the higher value and the lower value.

In the exemplary embodiment of FIGS. 5A to 5D, there is provided a controlled variable resistance system 26 whose resistance value, seen by an electric current flowing in the main electric circuit, can vary continuously or almost continuously between the higher value and the lower value. Thus, the controlled variable resistance system 26 may be embodied as a rheostat. FIG. 5A illustrates a rheostat 44 arranged in the main circuit 24 downstream of the cut-off apparatus 22. For example, a movable switching slider 46 of the rheostat 44 is electrically connected to a downstream terminal 25 of the cut-off apparatus 22 while an elongated resistive element 48 of the rheostat 44 is connected, through a downstream end 50, to the downstream part of the main electric circuit 24. Each displacement of the switching slider 46 corresponds to a switching of the resistance value of the rheostat 44.

In the initial state illustrated in FIG. 5A, in which the cut-off apparatus 22 is still in its open state, the slider 46 is placed to set the resistance value of the rheostat to a higher value. In this configuration, the cut-off apparatus 22 is closed at a closing instant T0. From there, the resistance value of the rheostat 44 can be varied by progressively moving the slider up to an instant T2, illustrated in FIG. 5D, at which the resistance value of the rheostat 44 is a lower value. Between these two instants, the resistance value of the rheostat 44 is changed in a continuous or quasi-continuous manner so that, for example at an instant T1 illustrated in FIG. 5C, the resistance value of the rheostat 44, seen by the electric current flowing in the main circuit 24, is an intermediate value comprised between the higher value and the lower value. The displacement of the slider 46 is controlled by the coordination device 32 of the installation. The speed of displacement of the slider 46, and therefore the variation of the resistance value of the controlled variable resistance system 26, may be constant or may be variable. The displacement of the slider 46 may comprise stages during which the displacement is interrupted, therefore during which the resistance value remains fixed for a certain time. The rheostat may be a linear rheostat in which the resistive element 48 is elongated in a rectilinear direction or a rotary rheostat in which the resistive element 48 is elongated along a curve.

FIG. 6 illustrates a variant of the invention in which the controlled variable resistance system 26 has:
a first insertion switch S1 and a first associated insertion resistor R1 which are arranged electrically in series in the same first bypass branch 51 of the electric circuit;
a second insertion switch S2 and a second associated insertion resistor R2 which are arranged electrically in series in the same second bypass branch of the electric circuit, bypassing the main electric circuit.

The first bypass branch 51 and the second bypass branch 52 are arranged electrically in parallel with each other and the two branches are arranged electrically in parallel with the cut-off apparatus 22.

The insertion resistors R1, R2 in parallel form a resistance device of the controlled variable resistance system 26, while the insertion switches S1 and S2 form a switching device of the controlled variable resistance system 26.

In normal operation, the cut-off apparatus 22 is closed and the two switches S1, S2 arranged electrically in parallel are open.

Upon opening of the cut-off apparatus 22, the insertion switches S1 and S2 and the insertion resistors R1, R2 of the controlled variable resistance system 26 do not interfere.

Upon turning-on, at an instant T′0, for example the first insertion switch S1 associated with the resistor R1 is closed at first. It is noted that the resistor R1 then represents the higher resistance value seen by the main current. The setting of the resistance value of the resistance system with a controlled variable resistance, to a higher value and the establishment of the flow of an electric current through the resistance system with a controlled variable resistance, are thus simultaneously obtained.

On expiry of a first period, at an instant T′1, the second insertion switch S2 is closed. The two parallel insertion resistors R1 and R2 have an intermediate equivalent resistor. The modification of the resistance value of the resistance system 26 into an intermediate value is thus obtained. Then, on expiry of a second period, at a time T′2, the cut-off apparatus 22 is closed, which has the effect of short-circuiting the insertion resistors R1, R2 of the controlled variable resistance system 26, which then has a minimum resistance value for the current flowing in the main circuit 24.

It should be noted that, unlike the previous embodiments, the switching instants T′0 and T1′ of the switches S1 and S2 of the controlled variable resistance system 26 are prior to the closing instant T′2 of the cut-off apparatus 22 from its open state to its closed state

Then, the two insertion switches S1 and S2 of the controlled variable resistance system 26 can be reopened to be ready for a subsequent operation. These openings are made without current since the electrical power transits through the cut-off apparatus 22.

Of course, analogously to the embodiment of FIG. 3, more than two bypass branches could be provided, for example three bypass branches, each including a switch and an associated resistor arranged electrically in series, the bypass branches being arranged electrically in parallel with each other and the branches being arranged electrically in parallel with the cut-off apparatus 22, to determine at least two distinct non-zero intermediate values comprised between the lower value and the higher value. Similarly, analogously to the embodiment of FIG. 4, the insertion switches in the embodiment of FIG. 6 may comprise electronic switches, for example of the thyristor, TRIAC, MOSFET, IGBT types, etc.

In the illustrated examples, the lower value of the resistance value of the controlled variable resistance system 26 is a zero resistance value or can be considered as such. However, in some embodiments, it can be expected that this lower value is non-zero.

More generally, with a controlled variable resistance system for obtaining (k−1) intermediate resistance values, k being an integer equal to or greater than 2, comprised between a higher value RSysEqSup and a lower value RSysEqInf, distinct from each other and distinct from the higher value RSysEqSup and from the lower value RSysEqInf, the method includes:
the setting of a resistance value of a resistance system with a controlled variable resistance 26, seen by the current flowing in the electric circuit, to the higher value RSysEqSup;
the establishment T0, T′0 of an electrical flow in the DC high-voltage electric circuit 24 through the resistance system with a controlled variable resistance 26;
the modification of the resistance value of the resistance system 26 to reach, on expiry of an (i)^{th} period T(i)−T0 following the establishment of the electrical flow, an intermediate value RSysEq(i+1);
and then the modification of the resistance value of the resistance system 26 to reach, on expiry of a (k)^{th} period (k)−T0 following the establishment of the electrical flow, a lower value RSysEqInf.

Preferably, the system is configured, for example by a suitable choice of the resistive components, so that the higher resistance value RSysEqSup of the resistance system, seen by the current flowing in the electric circuit, is equal to or greater than the quotient of the voltage of the network Udc by the current of desired maximum peak Ides, quotient from which is removed the equivalent wave impedance value Zeq of the electric circuit 24 in which the current is to be restored, including any network connected to the main circuit but excluding the controlled variable resistance system, according to the following formula:

$$RSysEqSup = \frac{Udc}{Ides} - Zeq$$

This choice allows limiting the current in the main circuit 24 to the desired value Ides. This value is, for example, chosen to correspond to a certain percentage (less than 100) of the current value of blocking the IGBTs of converters present in the network.

Generally, in some embodiments, the resistance value of the resistance system with a controlled variable resistance 26 is controlled to take a succession of decreasing discrete values RSysEq(i). Note that when the controlled variable resistance system 26 is in the form of a rheostat, it can generally be considered that the rheostat determines a large number of successive discrete values.

Similarly, the inventors have determined that the system should be preferably controlled to ensure certain duration of insertion for a given value of the resistance value of the resistance system with a controlled variable resistance 26. Such duration of insertion of an intermediate value RSysEq(i), is the duration for which the resistance value of the resistance system with a controlled variable resistance 26 is controlled to take said discrete intermediate value RSysEq(i). T(i−1) is then noted the instant at which the resistance system with a controlled variable resistance 26 is controlled to take said intermediate value RSysEq(i), and T(i) the instant at which the resistance system with a controlled variable resistance 26 is controlled to move from said intermediate value RSysEq(i) to the next resistance value RSysEq(i+1). The next resistance value RSysEq(i+1) is the next resistance value in the order of succession of the discrete resistance values of the resistance system with a controlled variable resistance 26, seen by the current flowing in the electric circuit. The duration of insertion is therefore the duration T(i)−T(i−1). It is noted that, considering the convention that the instant T0 or T′0 of establishing an electrical flow in the DC high-voltage electric circuit (24) constitutes the origin of the times, with T0=0; the value of the instant T (i) at which the resistance system with a controlled variable resistance 26 is controlled to move from said intermediate value RSysEq(i) to the next resistance value RSysEq(i+1) is equal to the elapsed period following the establishment of the electrical flow.

It has therefore been determined that the duration of insertion should be preferably equal to or greater than:

$$- ln ( \frac{RSysEq ( i + 1 ) + Zeq}{RSysEq ( i ) + Zeq} ) \cdot RSysEq ( i ) \cdot Ceq$$

where Ceq and Zeq are respectively the equivalent capacitance and the equivalent wave impedance value of the electric circuit 24 in the current is to be restored, including any network connected to the main circuit, excluding any influence of the resistance system with a controlled variable resistance 26. Ceq and Zeq result in particular from the topology of the main circuit 24, comprising the network connected thereto, and in particular from the specific characteristics of the lines used in this topology. Depending on the complexity of the topology in question, the quantities Ceq and Zeq can be deduced analytically, by numerical simulation or by experimental measurements of the current and voltage values in the electric circuit 24 upon the establishment of a reference current.

The parameter Zeq can be determined from the voltage of the network Udc and the draw current without the presence of the controlled variable resistance system, while the parameter Ceq can be determined from the exponential change of the established current following the closing of the cut-off apparatus on any resistance placed in series with the cut-off apparatus.

Of course, this formula gives a minimum value of the insertion duration, valid for a predefined series of resistance values (RSysEqSup, RSysEq(i), RSysEqSup) of the resistance system with a controlled variable resistance 26, to allow a rapid restoration of the current in the main circuit 24 without exceeding the current peak value Ides. In practice, it will be advantageous to provide a higher value, for example ranging from 1 time to 1.5 times the value given by the formula above, in order to ensure compliance with the limitation of the current to the desired value Ides, despite for example uncertainties as to the values of resistance, capacitance, or response time of the elements in the main circuit 24.

It is possible to choose or determine an optimized series of resistance values (RSysEqSup, RSysEq(i), RSysEqInf) of the resistance system with a controlled variable resistance 26, to further optimize the total time required to restore the current, that is to say, the period Tk−T0 which extends from the instant T0, T′0 of establishing an electrical flow in the DC high-voltage electric circuit 24 up to the instant Tk for which the resistance value of the resistance system 26 reaches the lower value RSysEqInf.

It is thus possible to determine such an optimized series of resistance values of the resistance system with a controlled variable resistance 26 by implementing conventional optimization methods in particular iterative calculation methods. For example, the parameters that can be iteratively varied may be:
a first insertion duration Ti, for a resistance value of the system 26, for example the higher value RSysEqSup, by varying it from the value 0 up to the maximum value that can take an insertion duration;
the resistance values of the resistance system RSysEq(1) to RSysEq(k), each varying from the value 0 up to the maximum value that a resistance can take.

With such iterations, it is then possible to calculate, iteratively
the second intermediate value RSysEq(2) of the resistance system (26);
The other insertion durations T(i)−T(i−1).

By these iterations, and by implementation of a minimization function, the minimum value of the total insertion duration Tk−T0 is sought.

Of course, other optimization calculation methods can be used. In practice, some real or simulation tests can be enough to determine an optimized otherwise an absolutely optimal series.

The invention is not limited to the examples described and represented because various modifications can be made thereto without departing from its scope.

1.-23 (canceled)

24. A DC high-voltage electrical installation comprising an apparatus for cutting-off a DC high-voltage electric circuit, of the type comprising a main circuit in which flows an operating electric current under DC high-voltage during a steady operating state of the installation, the cut-off apparatus being likely to switch from an open state in which it interrupts the flow of an electric current in the main circuit to a closed state in which it allows the flow of an electric current in the main circuit,
wherein the installation includes a controlled variable resistance system comprising a resistance device associated with a switching device for modifying the resistance value of the resistance system, seen by the current flowing in the main electric circuit, said resistance value taking at least three distinct values, comprising at least one higher value, one lower value, and at least one non-zero intermediate value comprised between the lower value and the higher value, and in that the installation includes a coordination device for controlling switching instants of the resistance values of the resistance system as a function of a closing instant of the cut-off apparatus from its open state to its closed state.

25. The electrical installation according to claim 24, wherein the installation includes a controlled variable resistance system for which said resistance value takes at least two distinct non-zero intermediate values comprised between the lower value and the higher value.

26. The electrical installation according to claim 24, wherein the resistance device includes at least two discrete insertion resistors, and in that the switching device includes at least two distinct insertion switches, separate from the cut-off apparatus, which present each an open state of current interruption through the switch and a closed state of current passage through the switch, and which are each associated with a respective associated discrete insertion resistor for selectively controlling the passage of the current in the associated discrete insertion resistor.

27. The electrical installation according to claim 26, wherein at least one insertion switch is arranged in the main circuit so as to be, in its closed state, traversed by the operating current, and in that the associated discrete insertion resistor is arranged in the main circuit electrically in parallel with the associated insertion switch.

28. The electrical installation according to claim 26, wherein first and second insertion switches are arranged in the main circuit so as to be traversed by the operating current in their closed state, and in that first and second discrete insertion resistors, respectively associated with the first and second insertion switches, are each arranged respectively electrically in parallel with the associated insertion switch.

29. The electrical installation according to claim 26, wherein at least a first switch and a first associated resistor are arranged electrically in series in a same first bypass branch of the electric circuit, in that a second switch and a second associated resistor are arranged electrically in series in a same second bypass branch of the electric circuit, the first bypass branch and the second bypass branch being arranged electrically in parallel with each other and the two branches being arranged electrically in parallel with the cut-off apparatus.

30. The electrical installation according to claim 26, wherein at least one insertion switch is mechanical.

31. The electrical installation according to claim 26, wherein at least one insertion switch is electronic.

32. The electrical installation according to claims 26, wherein at least one insertion switch is mechanically controlled by a displacement of at least one member of the cut-off apparatus.

33. The electrical installation according to claim 26, wherein at least one insertion switch is electronically controlled.

34. The electrical installation according to claim 24, wherein the controlled variable resistance system comprises a rheostat comprising a resistive element associated with a movable switching slider controlled in displacement to change the resistance value of the resistance system seen by the current flowing in the electric circuit.

35. The electrical installation according to claim 34, wherein the movable switching slider is controlled in displacement by the coordination device.

36. The electrical installation according to claim 24, wherein the coordination device includes an electronic control unit.

37. The electrical installation according to claim 24, wherein the cut-off apparatus is a circuit breaker.

38. The electrical installation according to claim 24, wherein the higher resistance value (RSysEqSup) of the resistance system, seen by the current flowing in the main circuit, is equal to or greater than the quotient of the voltage of the network (Udc) by the current of desired maximum peak (Ides), quotient from which is removed the equivalent wave impedance value (Zeq) of the electric circuit excluding the controlled variable resistance system:
$$RSysEqSup = \frac{Udc}{Ides} - Zeq$$

39. The electrical installation according to claim 24, wherein the resistance value of the resistance system with a controlled variable resistance is controlled to take a succession of decreasing discrete values (RSysEq(i)), and in that the switching device is configured so that an insertion duration (Ti−T(i−1)) of an intermediate value (RSysEq(i)), for which the resistance value of the resistance system with a controlled variable resistance is controlled to take said discrete intermediate value (RSysEq(i)), is equal to or greater than:
$$- ln ( \frac{RSysEq ( i + 1 ) + Zeq}{RSysEq ( i ) + Zeq} ) \cdot RSysEq ( i ) \cdot Ceq$$
Where:
RSysEq(i) is an intermediate resistance value of the resistance system with a controlled variable resistance, seen by the current flowing in the electric circuit;
T(i−1) is the instant at which the resistance system with a controlled variable resistance is controlled to take said intermediate value (RSysEq(i));
RSysEq(i+1) is a next resistance value in the order of succession of the discrete resistance values of the resistance system with a controlled variable resistance, seen by the current flowing in the electric circuit;
T(i) is the instant at which the resistance system with a controlled variable resistance is controlled to move from said intermediate value (RSysEq(i)) to the next resistance value (RSysEq(i+1));
Zeq is the equivalent wave impedance value of the electric circuit, including any network connected to the main circuit, but excluding the controlled variable resistance system;
Ceq is the equivalent capacitance of the electric circuit, including any network connected to the main circuit.

40. A method for controlling the closing of a cut-off apparatus in a DC high-voltage electric circuit of a DC high-voltage electrical installation, wherein the method includes:
the setting of a resistance value of a resistance system with a controlled variable resistance, seen by the current flowing in the electric circuit, to a higher value;
the establishment of an electrical flow in the DC high-voltage electric circuit through the resistance system with a controlled variable resistance;
the modification of the resistance value of the resistance system to reach, on expiry of a first period following the establishment of the electrical flow, an intermediate value;
after expiry of the first period following the establishment of the electrical flow, the modification of the resistance value of the resistance system to reach, on expiry of a second period following the establishment of the electrical flow, a lower value.

41. The method for controlling the closing of a cut-off apparatus according to claim 40, wherein the method includes:
the setting of a resistance value of a resistance system with a controlled variable resistance, seen by the current flowing in the electric circuit, to a higher value (RSysEqSup);
the establishment of an electrical flow in the DC high-voltage electric circuit through the resistance system with a controlled variable resistance;
the modification of the resistance value of the resistance system to reach, on expiry of an (i)th period following the establishment of the electrical flow, an intermediate value (RSysEq(i+1));
and then the modification of the resistance value of the resistance system to reach, on expiry of a (k)th period following the establishment of the electrical flow, a lower value (RSysEqInf).

42. The method for controlling the closing of a cut-off apparatus according to claim 40,
wherein the higher resistance value (RSysEqSup) of the resistance system, seen by the current flowing in the electric circuit, is equal to or greater than the quotient of the voltage of the network (Udc) by the current of desired maximum peak (Ides), quotient from which is removed the equivalent wave impedance value (Zeq) of the electric circuit excluding the controlled variable resistance system:
$$RSysEqSup = \frac{Udc}{Ides} - Zeq$$

43. The method for controlling the closing of a cut-off apparatus according to claim 40, wherein the resistance value of the resistance system with a controlled variable resistance is controlled to take a succession of decreasing discrete values (RSysEq(i)), and in that a duration of insertion (Ti−T(i−1)) of an intermediate value (RSysEq(i)), for which the resistance value of the resistance system with a controlled variable resistance is controlled to take said discrete intermediate value (RSysEq(i)), is equal to or greater than:
$$- ln ( \frac{RSysEq ( i + 1 ) + Zeq}{RSysEq ( i ) + Zeq} ) \cdot RSysEq ( i ) \cdot Ceq$$
Where:
RSysEq(i) is an intermediate resistance value of the resistance system with a controlled variable resistance, seen by the current flowing in the electric circuit;
T(i−1) is the instant at which the resistance system with a controlled variable resistance is controlled to take said intermediate value (RSysEq(i));
RSysEq(i+1) is a next resistance value in the order of succession of the discrete resistance values of the resistance system with a controlled variable resistance, seen by the current flowing in the electric circuit;
T(i) is the instant at which the resistance system with a controlled variable resistance is controlled to move from said intermediate value (RSysEq(i)) to the next resistance value (RSysEq(i+1));
Zeq is the equivalent wave impedance value of the electric circuit, including any network connected to the main circuit, excluding the controlled variable resistance system;
Ceq is the equivalent capacitance of the electric circuit, including any network connected to the main circuit.

44. The method for controlling the closing of a cut-off apparatus according to claim 43, wherein the duration of insertion (Ti−T(i−1)) of an intermediate value (RSysEq(i)), for which the resistance value of the resistance system with a controlled variable resistance is controlled to take said discrete intermediate value (RSysEq(i)), is ranging from 1 time to 1.5 times the value:
$$- ln ( \frac{RSysEq ( i + 1 ) + Zeq}{RSysEq ( i ) + Zeq} ) \cdot RSysEq ( i ) \cdot Ceq$$

45. The method for controlling the closing of a cut-off apparatus according to claim 40, wherein the method includes:
the setting of a resistance value of a resistance system with a controlled variable resistance, seen by the current flowing in the electric circuit, to a higher value;
the closing of the cut-off apparatus;
after the closing of the cut-off apparatus, the modification of the resistance value of the resistance system to reach, on expiry of a first period, following the closing of the cut-off apparatus, an intermediate value;
after expiry of the first period, the modification of the resistance value of the resistance system to reach, on expiry of a second period following the closing of the cut-off apparatus, a lower value.

46. The method for controlling the closing of a cut-off apparatus according to claim 40, wherein the method includes:
the setting of a resistance value of a resistance system with a controlled variable resistance, seen by the current flowing in the electric circuit, to a higher value, and the establishment of the flow of an electric current through the resistance system with a controlled variable resistance by the closing of an insertion switch;
the modification of the resistance value of the resistance system to reach, on expiry of a first period, following the establishment of the flow of an electric current through the resistance system with a controlled variable resistance, an intermediate value, by the closing of a second insertion switch;
after expiry of the first period, the modification of the resistance value of the resistance system to reach, on expiry of a second period following the establishment of the flow of an electric current through the resistance system with a controlled variable resistance, a lower value, by the closing of the cut-off apparatus.
